(19) United States
(12) Patent Application Publication
(10) Pub. No.: US 2008/0190173 A1
(43) Pub. Date: Aug. 14, 2008

(54) Soot Sensor

(75) Inventors: Karlheinz Wienand, Aschaffenburg (DE); Matthias Muziol, Mainhausen (DE); Tim Asmus, Langenselbold (DE); Karlheinz Ullrich, Gross-Umstadt (DE); Andreas Ogrzewalla, Barcelona (ES); Dieter Teusch, Bruchkobel (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HERAEUS SENSOR TECHNOLOGY GMBH, Hanau (DE)

(21) Appl. No.: 11/912,194

(22) PCT Filed: Apr. 20, 2006
(86) PCT No.: PCT/EP2006/003640

§ 371 Date: Dec. 5, 2007

(30) Foreign Application Priority Data
Apr. 20, 2005 (DE) 10 2005 018 453.7
Jun. 22, 2005 (DE) 10 2005 029 219.4

(51) Int. Cl. G01N 37/00; G01N 27/04; B01J 19/00

(52) U.S. Cl. 73/28.01; 422/68.1; 422/82.02; 422/82.12

(57) ABSTRACT

The present invention relates to soot sensors based on one-piece strip conductor structures, to methods for measuring soot, and to the use of heat conductor chips for soot measurement. For this purpose, the invention is based on the sensitivity of intensive variables, especially substance-specific variables.

According to the invention, an electric soot sensor is provided, in which at least one chip is provided with at least one one-piece strip conductor having, in particular, two terminal panels, and the soot sensor has a soot determination facility that is adapted to determine an intensive or specific change of a surface.

The inventive method is characterized by soot deposits causing a change of an intensive variable, especially of a thermospecific or electrical parameter of a chip, and by determination of said variable.

The present invention relates to soot sensors based on one-piece strip conductor structures, methods for measuring soot, and the use of heat conductor chips for soot measurement.

DE 199 59 870 A1 describes a soot sensor that uses a heating element to heat the soot to ignition temperature and uses a temperature sensor to analyze the temperature increase as a direct measure of the combusted quantity of soot particles. One disadvantage of this indirect measurement is its lack of reproducibility. The flow situation in the exhaust system must be known in order to be able to derive information from the temperature increase. Moreover, the very complex three-dimensional structure of the element is very susceptible to failure and expensive.

In accordance with DE 33 04 846, the difference in heating power of a soot-covered heating surface is compared to an essentially soot-free heating surface.

DE 103 31 838 relates to a sensor element having a roughened sensor surface for soot deposition, in which the thermal mass of the sensor body is determined as a measure of its soot contamination. For this purpose, the sensor is heated by means of a resistor structure and the same resistor structure is used to record the temperature of the sensor body.

In all methods cited above, a small change of a large variable is measured as rapidly as possible in order for the measured effect to predominate over other effects. Essentially, this concerns changes of extensive variables, in particular the small increase in the mass of the sensor caused by soot deposits. The effects thus measured are essentially based on the small change of the mass of the sensor due to soot deposition.

It is the object of the present invention to allow reproducible qualitative and quantitative statements to be made with regard to soot particles, in particular in as far as it concerns the quantity and size of the soot particles in order to be able to assess the soot particle filter in terms of filling degree and function.

To solve this object, the sensitivity of intensive variables, in particular substance-specific variables, is taken into consideration. In terms of method, measurement of intensive variables that are changed by soot deposition is taken into consideration. In terms of device, increases in sensitivity for improved detection of the influence of soot on intensive variables are effected. Preferably, a direct soot measurement is made with heat conductors, in particular with one or two heat conductors. Corresponding solutions for sensors, methods for soot measurement with heat conductors, as well as the use of heat conductors for soot measurement are the subject matter of the independent claims. Preferred embodiments are defined in the dependent claims.

What is relevant is that clear changes of the measured variables are required for measurements to be reproducible. Intensive variables, in particular specific variables of a chip, are better suited for this purpose than the measurements according to the prior art that are based on extensive effects. Effects that are based on changed surface properties and which change the surface optically or in terms of heat conduction, e.g. by means of insulation or electrically, in particular in terms of scatter field, are based on intensive and specific variables that are being utilized for solutions according to the invention. Optical changes arise from soot coverage of a metallic surface whereby the increasing soot motion tends in the direction of creating a black body. Accordingly, in terms of heat conduction, the emission behaviour of the surface changes, and thus the measurable temperature equilibrium between supplied and emitted energy changes. On a ceramic surface, soot motion acts in a heat-insulating fashion and, in the process, creates a changed temperature behaviour. Acting as a dielectric, soot deposits on an electrode structure reduce the insulation of the strip conductors and reduce the resistance of the electrode structure. In this regard, it has been found that soot coverage can have a marked influence on the specific electric properties, that the cooling of the chips having adequate surfaces can be made to be clearly dependent on the soot contamination, and that combustion of the soot coverage can have a marked effect on the temperature profile. The signals determined using the measuring units are balanced against reference values or reference curves or comparative measurements in order to set or calibrate the soot sensor.

Combusting the soot on the heat conductor increases its resistance. This resistance can be determined by means of an electric circuit. The degree of soot contamination can be concluded from the resistance, in particular from its time profile. Preferably, a characteristic curve of the resistance by degree of soot contamination is determined. This characteristic curve allows the degree of soot contamination to be determined.

The electrical resistance of an electronic pattern, in particular a heat conductor, can be designed to be dependent on the soot coverage and the soot coverage can be determined by means of the electrical resistance. This means that a change of characteristic parameters of the chip is being made. In the process, chip-specific variables are changed, i.e. at least not only the temperature dependencies, which are inherently difficult to control under robust conditions, are being utilized. If the insulating effect of air is reduced by soot, the specific conductivity of the electrical pattern of the chip and/or the specific resistance of the electrical pattern of the chip changes tremendously. In analogy, soot decreases the resistance of a resistor pattern, in particular of a meander-like resistor.

Electronic patterns can be manufactured either by thick-film technology or thin-film technology. Utilizing thin-film technology, electronic patters having strip conductors can be made from layers less than 1 μm in thickness to have a strip width of less than 10 μm.

Electric patterns provided in a one-piece design are continuous electric conductor structures, provided in the form of resistors, in particular heat conductors or measuring resistors. IDC structures, in contrast, are not designed to be one-piece. Preferred patterns are snake-shaped or meander-shaped strip conductors. In preferred embodiment, strip conductors are tapered between their ends. The broad ends are called terminal contact panels.

In the scope of the present invention, chips comprising a heat conductor are called heat conductor chips. Paralleling the soot contamination of a sensor, the electrical resistance of heated heat conductor sensors and the temperature decreases over time relatively the more, the less heat the sensor can emit originally. This effect is quite pronounced in surface-plated heat conductors sensors. Accordingly, chips with unprotected heat conductors show a relatively more pronounced decrease of temperature and electrical resistance with increasing soot contamination than chips whose heat conductor is protected by white ceramics. The more extensively the surface of the chip is plated, the more pronounced is the soot contamination-effected decrease in temperature and/or its temperature profile and thus the electrical resistance and/or the time profile of the electric resistance of the chip. Accordingly, the resistance at constant heat power is decreased by soot contamination. Particularly marked effects can be obtained by gold coating. Upon the application of high temperatures, the temperature stability of platinum or iridium can become limiting.

Soot coverage also changes the specific temperature behaviour and the specific emission, in particular the IR emission characteristics of a heat conductor. At constant power consumption, increasing soot coverage is associated with an increase of the emitted power, whereby the temperature of the heat conductor chip drops accordingly. The soot contamination can therefore also be determined by determining the temperature of the heat conductor or its emission characteristics.

The combustion of the soot also affects the power consumption and the temperature. Upon soot-removing combustion, the electrical resistance of the soot-contaminated heat conductor sensor increases as compared to the non-soot-contaminated state. As before, this effect is the more pronounced; the smaller the amount of heat that the non-soot-contaminated sensor can dissipate.

Soot sensors having multiple strip conductors can be designed to have IDC structure. The resistor structure is, in particular, a heat conductor or temperature sensor. A measuring resistance is 10 to 100-fold higher than the resistance of a heat conductor.

Basically, all sensors having strip conductors on which soot can be deposited—in particular heat conductors—can be used as soot sensors.

A method and a soot sensor, as solution of the present invention, are based on a chip with terminal panels and electrical terminals, said chip having one electrical property that can be changed due to the effect of soot, in particular its resistance.

Preferably, the soot sensors are heat-resistant such as to also be useful in the exhaust of automobiles. In this regard, platinum thin-film technology is time-proven in the manufacture of corresponding chips. The heat conductors and, if applicable, further functional structures can be covered with a thin ceramic film, in order to further increase the temperature stability.

In the preferred embodiment having one heating element, the soot-sensitive chip can self-regenerate by removing the soot coverage by combustion. In this context, the heating element can be used for soot measurement by analyzing the heat conductor behaviour with regard to its electrical or thermal effect as a function of soot coverage.

In an embodiment having two heating resistors, the reproducibility of the measurements can be increased by means of relative measurement. In particular in an embodiment having two heating resistors, the soot coverage can be removed differentially by combustion and the different heating power, power consumption or temperature difference can be used for soot analysis.

In this context, the reproducibility can be increased simply by providing a chip with two heating resistors. In this set-up, the two measuring units can be used for mutual balancing. The mutual impact of the measuring units can be minimized by placing two chips having one measuring facility each at a distance from each other, which in turn increases the reproducibility.

An additional temperature sensor can contribute to the control of a combustion engine and thus to the control of soot formation or soot reduction. Combining the temperature sensor with a heating element, the temperature sensor can be used to obtain information regarding the quantity and nature of the soot at the time the soot is removed by combustion. Accordingly, it was found that the integral heat of combustion of small soot particles is lower than that of large soot particles, and that the integral heat of small soot particles is attained at lower temperatures than that of larger soot particles.

A temperature sensor can also be used for measuring the temperature and/or preparing a time-dependent temperature profile of a heat conductor.

In preferred embodiment, soot sensors, whose chips comprise high temperature-resistant materials exclusively, such as a ceramic substrate, on which a platinum meander structure is printed, and whose electrical supply leads are platinum-jacketed nickel-chromium alloys with a chromium content between 10 and 30%, are used for heat-resistant sensors in the automotive industry.

In other preferred embodiments
substrates are printed on, in particular using platinum, by means of the as-of-yet unpublished DE 10 2004 018 050 or by thin-film technology;
the width of the strip conductor of the heat conductor or temperature sensor is <2 μm;
the width of the strip conductor of the temperature sensor is narrower than 20 μm;
the heat conductor is coated with a protective layer.

Unprotected heat conductors are suitable for continuous use in exhaust gas at temperatures of up to 600° C., protected structures up to 850° C. It is preferred for the protected heat conductors to be plated on their outer surfaces.

The invention shall be illustrated in the following by means of examples and reference being made to the drawings. In the figures:

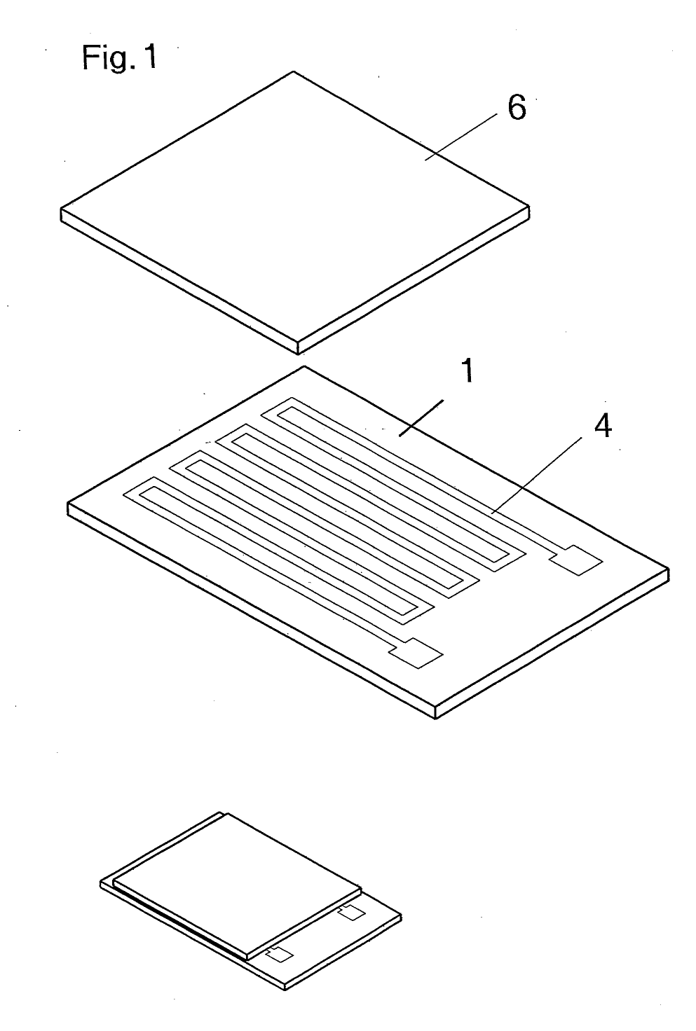

FIG. 1 shows an exploded view of a heat conductor chip;

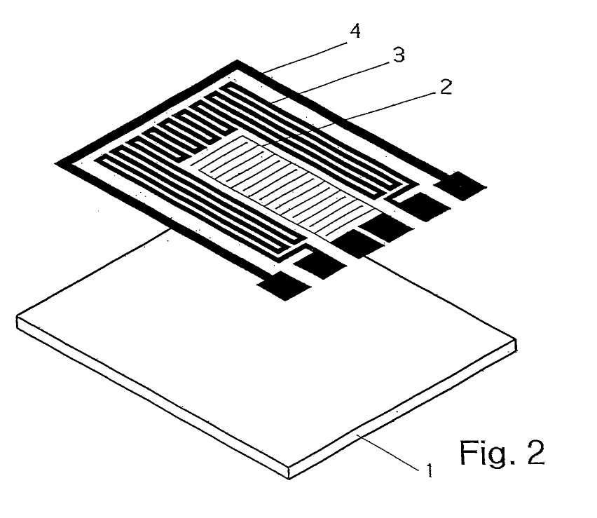

FIG. 2 shows a soot sensor chip, whereby conductor structures of a heating element and of a temperature sensor are attached in the same plane as the IDC structure;

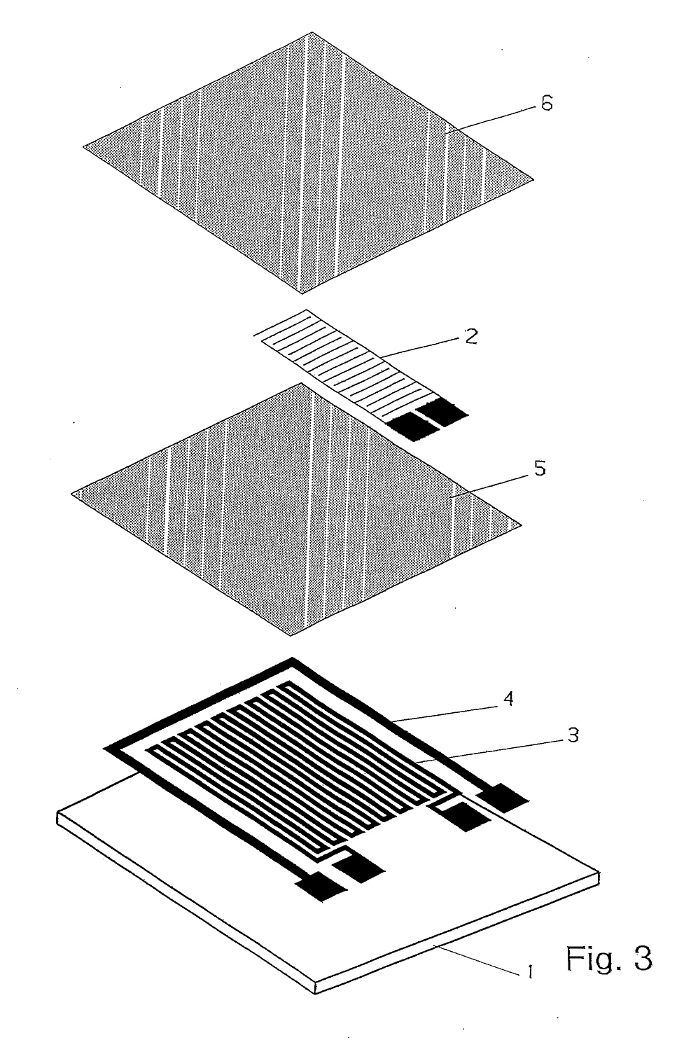

FIG. 3 shows a soot sensor chip, in which the conductor structures are arranged in multiple planes above each other;

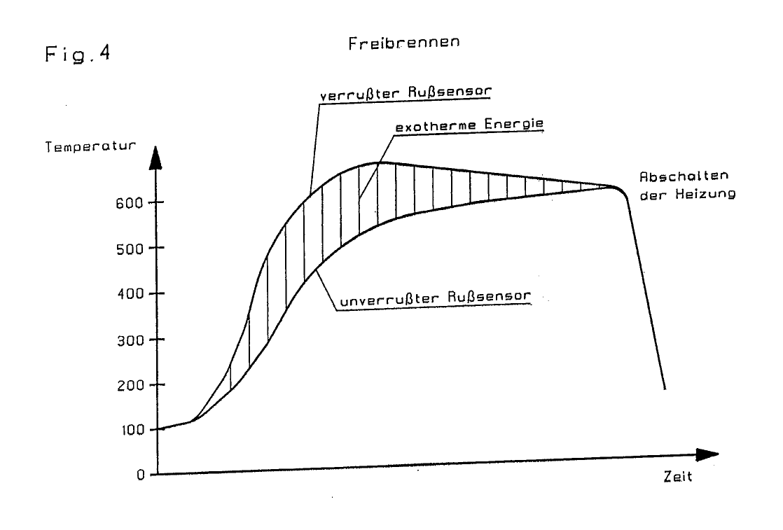

FIG. 4 shows the temperature profile during the combustion of finest soot as compared to the combustion of coarse-grained soot;

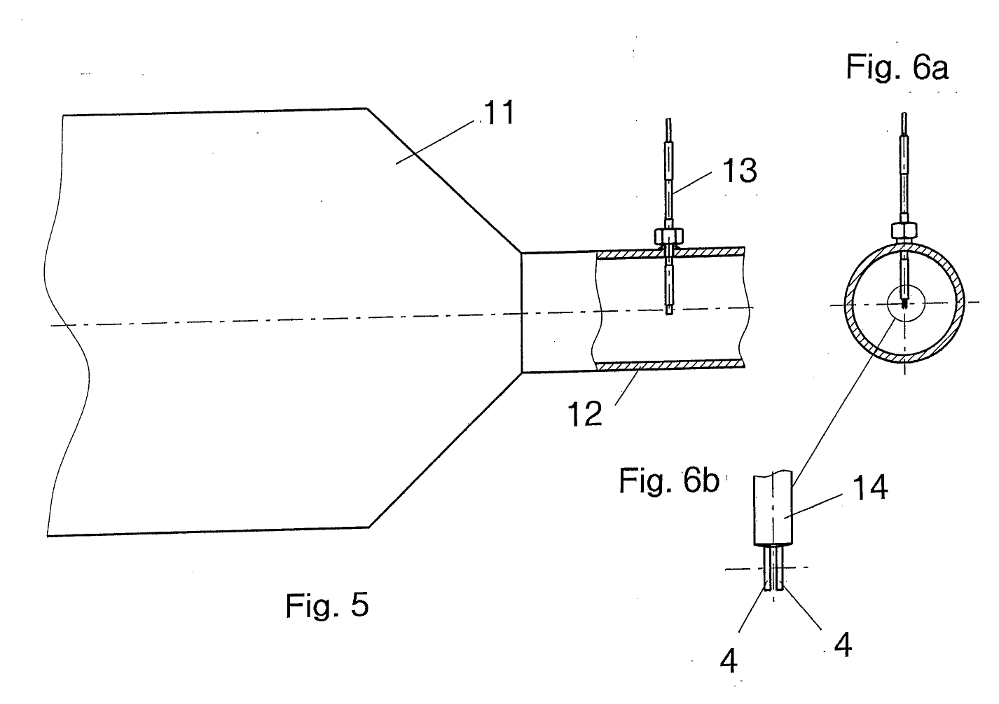

FIG. 5 shows a cross-section of a soot particle filter, exhaust duct attached thereto, and a soot sensor projecting into the exhaust gas duct;

FIG. 6a shows a top view of the sensor projecting into the exhaust gas duct and FIG. 6b shows a magnified view of its measuring tip;

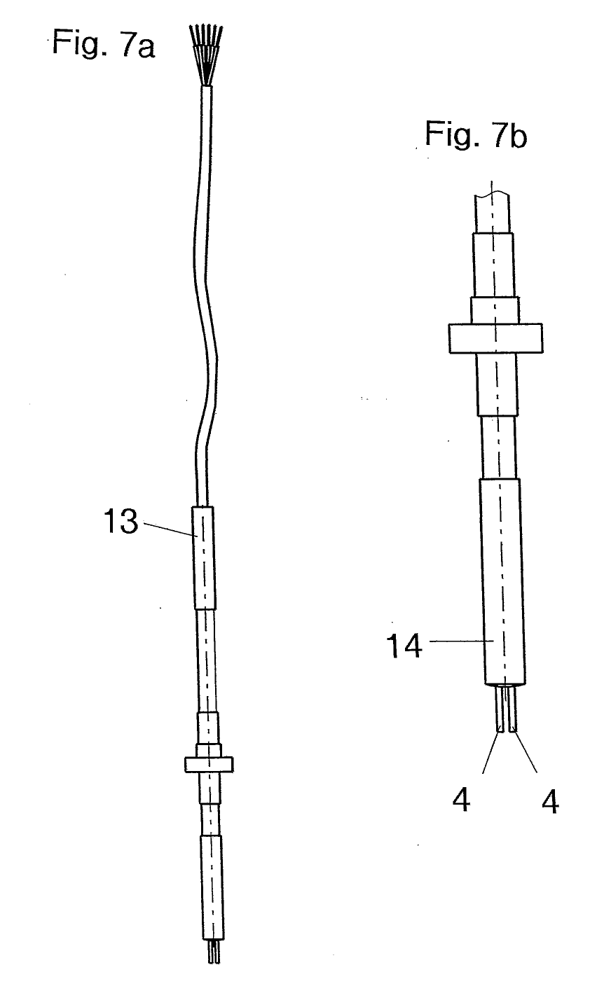

FIG. 7a shows another sensor and FIG. 7b shows its measuring tip;

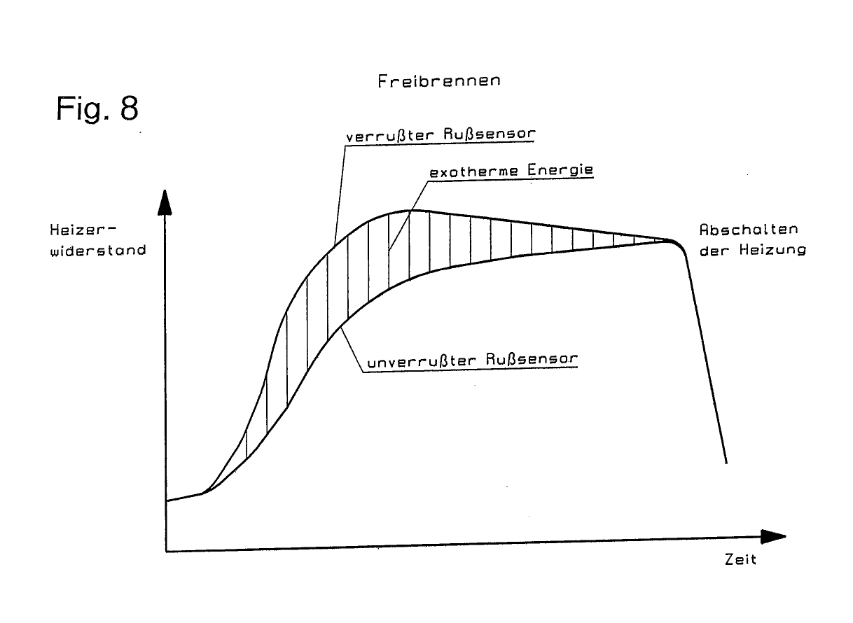

FIG. 8 shows a heating resistor sensor during the combustion of soot as a function of time as compared to a non-soot-contaminated heating resistor sensor;

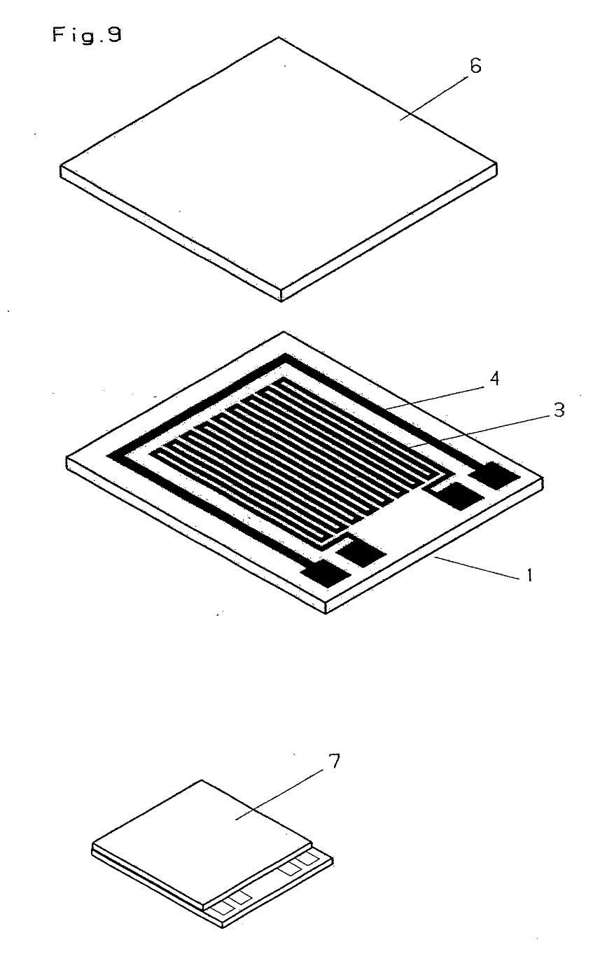

FIG. 9 shows an exploded view of a heat conductor chip having an integrated temperature measuring resistor; and

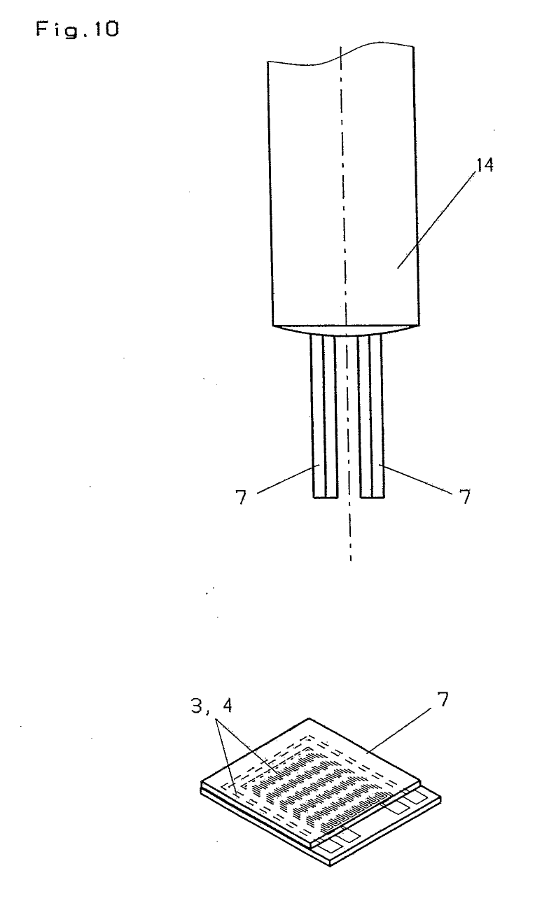

FIG. 10 shows two members according to FIG. 9 projecting from a protective tube.

In a simple embodiment according to FIG. 1, only a heat conductor 4, preferably made of platinum, is applied on a substrate 1, preferably a ceramic substrate 1, using thin-film technology. This can be effected in accordance with known lithographic methods or in accordance with the as-of-yet unpublished DE 10 2004 018 050. In this heat conductor chip, the resistance changes due to soot coverage which renders a heat conductor chip of this type suitable for direct soot measurement in exhaust gases. A particularly important application is the measurement of soot in exhaust gases of combustion engines, in particular Diesel engines. In particular, the function of the soot particle filter can be monitored and controlled by exhaust gases of Diesel engines.

The chip embodiment according to FIG. 2 is characterized by its extremely simple design that already renders convenient applications feasible. In analogy to FIG. 3, the platinum layer can be protected by a thin layer 6. It is also feasible to apply the thin film partly such that, for example, it covers only the heat conductor and the temperature sensor. In another embodiment according to FIG. 2, an insulating layer 6 is applied such that only the middle part of the IDC structure is not being printed on. Amongst this wide field of suitable protection options for potential applications, the embodiment according to FIG. 3 is notable, according to which the temperature sensor and the heat conductor are already protected by the insulating layer 5. Then, a chip according to FIG. 3 can, optionally, be manufactured to have an open IDC structure 2 or an IDC structure that is protected by an insulating layer 6.

Using heat conductors 4 according to FIG. 2 or 3, the soot deposited on the chip can be combusted by pyrolysis by heating it. For this purpose, heating temperatures of approx. 500° C. are time-proven. The IDC structure 2 or the measuring resistor 3 for determining the temperature are used for balancing the heating power for the conditions under which the heating power is afforded. The heating power afforded under certain conditions can be used to determine the soot and/or soot contamination.

The temperature sensor 3 according to FIGS. 3 and 4 can be used to analyze the combustion on the heat conductor chip. The temperature profile provides additional information with regard to the combustion heat of the soot combustion. Using reference values or reference curves, this allows conclusion to be made with regard to the type and nature as well as to the quantity of the soot. The quantity and particle size of the soot, in particular, can thus be detected, as is illustrated in FIG. 4.

In the new generation of Diesel engines, the soot is removed from the exhaust gas by filtration. In the process, the soot filter can become baked and clogged. In order to keep the soot filter effective, it is therefore recommended to reduce the soot coverage of the filter. For controlling and testing the self-cleaning, a sensor according to the invention can be arranged on the soot filter and become coated under the same conditions as the filter such that the self-cleaning of the particle filter is initiated by means of the sensor as soon as the sensor measures a defined value of an electrical variable. The sensor according to the invention can be used to control the explosion mixture via the fuel supply, air supply or exhaust recycling. By this means, exhaust gas mixtures can be generated that allow the soot formation to be controlled and, if applicable, reduced.

If soot particles deposit on a pre-heated platinum electrode comb structure (IDC), the electric resistance of the IDC structure 2 that is measured is a comparative measure for the concentration of the soot coverage. If the IDC structure 2 is passivated by a dielectric by thin-film passivation 6 or by a printed thick-film layer, the soot coverage of said dielectric affects the capacitance of the capacitor as a function of the soot concentration. The temperature-dependent values of the heating power and of the IDC measurement, balanced mutually, yield an exact measure of the soot contamination.

Thus, according to the invention, a quantitative detection of the soot particle concentration is facilitated by means of time-proven, robust ceramic chip design using platinum thin-film technology.

Additional heating and temperature sensor elements facilitate the analysis of the exothermal reaction during soot combustion by means of the temperature increase upon combustion of the soot layer. This exothermal reaction shows a correlation to the increase in temperature and can be recorded by means of an integrated temperature sensor. A comparison of the curve profile to archived curves allows conclusions regarding the quantity, distribution, and particle size of the soot to be made.

From the direct or alternating current conductivity, it is feasible to make conclusions concerning the degree of contamination and to initiate a soot-removing combustion process.

In the arrangement according to FIG. 5, the sensor projects into an exhaust duct 12 and is arranged either upstream or downstream from the soot particle filter 11. The tip 14 of the sensor 13 is provided with two chips in FIGS. 6a, 7, and 7a. Having two chips allows reference measurements with respect to the corresponding other chip to be made. If one chip comprises a heating facility 4 according to FIG. 1, the heating facility 4 can be used to remove the soot by combustion. Accordingly, the soot combustion can be analyzed with the sensor and further reference data can be obtained with the second sensor. The soot-removing combustion process on a chip detunes the measuring bridge that comprises both chips, whereby the detuning is a measure of the soot contamination and thus is a measure also of the condition of the particle filter 11. In order to balance the bridge, both chips are heated until the soot on them is removed by combustion. According to FIG. 1, the heat conductor chip 4 is protected by a protective layer 6. A ceramic coating and application using thin-film technology, in particular application of a ceramic coating using thin-film technology, are time-proven for this purpose. External gold, platinum or iridium plating increases the sensitivity for soot. Plating can be effected on the protective layer 6 and on the back of the ceramic substrate 1 using thin-film technology. The soot sensors thus manufactured can be used for continuous operation at temperatures of up to 850° C. Moreover, the protective layer 6 can be sealed to increase the serviceable life, for example using glass or a sacrificial electrode.

A simple protective layer made of glass is sufficient for applications up to 650° C.

The diagram in FIG. 8 illustrates on the soot-removing combustion process the increased heating resistance of a soot-contaminated sensor as compared to a sensor that is not soot-contaminated. In this context, it is important to note that upon heating of a soot-contaminated soot sensor and of a non-soot-contaminated soot sensor below the soot-removing combustion temperature, the soot-contaminated soot sensor stays colder, i.e. heats up more slowly.

Heat Conductor Chip having IDC Structure

The soot can be removed from the chip by means of a heat conductor. A sensor of this type can be operated such that the chip initiates, at a pre-determined impedance, a soot-removing combustion process by which the soot is removed from the soot filter from the chip itself as well. An additional temperature sensor is useful for further improvement of the reproducibility, for example in order to determine the temperature profile of the heat conductor or to carry out the measurement under standardized temperature conditions.

### Soot Measurement by Means of a Heat Conductor

A heat conductor according to FIG. 1 is calibrated under standard engine conditions in terms of its resistance characteristic curve with respect to the degree of soot contamination. A measurement in the inoperative state or idle operation is time-proven for this purpose. A sensor of this type can be arranged in the exhaust stream upstream or downstream from the soot particle filter 11. If the sensor is arranged downstream from the particle filter 11 and signals soot contamination, a defect of the soot filter 11 is displayed. A soot sensor that is arranged upstream from the soot filter 11 detecting soot contamination initiates the soot-removing combustion of the soot by its own heater 4 and in soot particle filter 11.

In a further embodiment, the heat conductor chip according to FIG. 1 is used to determine the soot contamination from the differential emission behaviour of the heat conductor 4. In the process, it was found that, below the combustion temperature, the resistance decreases with increasing soot contamination at identical heating power. This effect increases in magnitude the larger the difference in emission behaviour is. This is the reason to plate the outside of the heat conductor chip. Particularly well-suited for this purpose are gold, iridium, and platinum.

In an embodiment having two heat conductors 4, the drift with respect to the calibration curve can be prevented by means of a comparative measurement. Accordingly, the heat conductors 4 in this preferred embodiment can mutually combust the soot and be compared to each other. If they are operated under identical operating conditions, they are subject to the same drift by non-combustible soot components that get deposited on the surface.

The resistance of the heat conductor 4 adjusts with temperature. Upon soot contamination of a heat conductor 4, the heat conductor 4 changes its emission characteristics, since a soot-contaminated sensor, like a black emitter, emits more energy than other bodies.

Accordingly, the resistance of the heat conductor 4 decreases upon soot contamination which is the reason why the resistance of the heat conductor 4 can be utilized as a measure of the soot contamination. Consequently, the heat conductor 4 is suitable for initiation of a soot-removing combustion process for an analogously soot-contaminated soot filter 11. In the process, the soot sensor chokes up over time and drifts with respect to its characteristic resistance curve. For this reason, the resistance after the soot-removing combustion process is placed in a functional relationship to the parameters that are indicative of the soot-removing combustion process or the gas mixture formulation in a preferred embodiment. In a further improved embodiment for preventing the drift, two heat conductor 4-containing sensors are linked to form a measuring bridge. Of the numerous balancing options, the mutual soot-removing combustion and the reference measurement shall be emphasized here.

A component according to FIG. 9 comprises a measuring resistor 3 and a heating resistor 4. Two components 7 according to FIG. 9 are operated in a sensor according to FIG. 10, in that one of the two heat conductors 4 is used to remove soot from a component by combustion and then both heat conductors are used to heat the components until they reach their thermal equilibrium. The soot contamination is determined from the temperatures of the respective thermal equilibrium that is determined by means of the temperature-measuring resistors 3. The temperature difference of the components 7 therefore is a measure of the soot contamination.

Another exemplary embodiment according to FIGS. 9 and 10 shall be used to illustrate a further mode of action and a further measuring principle. Two ceramic soot sensor chips 7 (FIG. 9) are provided with a ceramic lid 6 that is attached by vitrification; the chips 7 each are provided with a heater 4 (rho approx. 20 Ohm) and a Pt-1000 sensor 3. The soot sensor chips 7 each are integrated into a housing (FIGS. 10 and 11). The two heaters 4 are electrically connected to two further precision measuring resistors of, for example, 20 Ohm each, in a Wheatstone bridge. The bridge voltage is amplified by a factor of 50 by means of an instrument amplifier module. The electrical bridge is then calibrated for the case of both chips 7 being soot-free with the temperature of the two heater chips 7 being selected to be in the 300° C. range. If one of the two chips 7 becomes soot-contaminated on the chip lid 6 or on the back of the chip or on both sides, the emission behaviour of said chip 7 changes as compared to a non-soot-contaminated chip 7 such that the soot-contaminated chip 7 emits more radiation and thus cools down to some degree. According to the characteristic curve for platinum, cooling of the soot-contaminated chip 7 changes the resistance of the heater 4 and thus leads to detuning of the Wheatstone bridge that is susceptible to being be measured.

If the soot-contaminated chip 7 is subjected to soot-removing combustion at temperatures above 600° C. for several minutes, no electrical detuning of the bridge can be measured any longer subsequently at the temperature range of 300° C.

In order to enhance the measuring effect, the total surface of the chip lid 6 and of the back of the chip are preferably plated with Au or Pt (e.g. by PVD coating) in order to minimize the emission behaviour in the infrared range.

1. Method for measuring soot deposits by means of one-piece electronic patterns, in particular by means of an electronic pattern that is manufactured to be one-piece using thin-film technology, characterized in that the soot deposits are determined by means of a change of an intensive (specific) parameter, in particular a thermospecific or electrical variable of a chip, which change is caused by the soot deposits.

2. Method for measuring soot deposits by means of one-piece electronic patterns, in particular by means of an electronic pattern that is manufactured to be one-piece using thin-film technology, characterized in that the soot deposits are determined by means of a change of an intensive specific electrical parameter of a chip by means of a heat conductor (4) or temperature sensor (3).

3. Method for determining soot deposits, in particular according to claim 1, characterized in that a sensor has two heat conductors (4) that are controlled differentially with respect to at least one of the variables, power consumption, temperature profile or profile of soot-removing combustion.

4. Method for determining soot according to claim 3, characterized in that two heat conductor chips are coated with soot and one soot-coated heat conductor chip is heated in order to remove the soot by combustion and the profile of power consumption or of the temperature or of power consumption and temperature are mutually analyzed in order to determine the soot properties.

5.-8. (canceled)

9. Electrical soot sensor, in which at least one chip is provided with at least one strip conductor that is provided to have one-piece design and has, in particular, two terminal panels, characterized in that the soot sensor has a soot determination facility that is adapted to determine an intensive or specific change of a surface.

10. Soot sensor in particular according to claim 9, containing at least one heat conductor chip, characterized in that the heat conductor chip is surface-plated on one, in particular on both, sides.

11. Soot sensor according to claim 9, characterized in that the soot sensor has two heat conductor chips (4).

12. Soot sensor according to claim 9, characterized in that the soot sensor comprises a chip that is connected to electrical terminals by means of terminal pads, whereby the resistance of the chip can be changed by soot impact.

13. Soot sensor according to claim 9, said soot sensor comprising a heat conductor chip whose electrical resistance can be changed by soot impact, characterized in that the sensor is balanced with regard to its resistance.

14. Soot sensor according to claim 9, characterized in that the soot sensor has a temperature sensor (3).

15. Soot sensor according to claim 9, characterized in that the heating element (4) or the temperature sensor (3) of the chip or multiple of these elements are covered by an electrical insulation (6).

16. Soot sensor according to claim 15, characterized in that the heating element (4) or the temperature sensor (3) are covered by a thin layer of ceramics (6).

17. Soot sensor according to claim 9, characterized in that the soot sensor has two components (7) which each have a heat conductor (4) and a temperature sensor (3).

18. Use of a soot sensor according to claim 17, characterized in that the soot contamination of a component 7 is determined by means of a second component 7 by means of reference measurement of the temperature at the same heating power or by reference measurement of the heating power at the same temperature.
